(19) United States
(12) Patent Application Publication
(10) Pub. No.: US 2024/0206678 A1
(43) Pub. Date: Jun. 27, 2024

(54) PIZZA OVEN INSERT FOR BARBECUE GRILL OR SMOKER

(71) Applicant: Masterbuilt Manufacturing, LLC, Columbus, GA (US)

(72) Inventors: Daniel MERCER, Hamilton, GA (US); William A. HARDY, Phenix City, AL (US)

(73) Assignee: Masterbuilt Manufacturing, LLC, Columbus, GA (US)

(21) Appl. No.: 18/597,276

(22) Filed: Mar. 6, 2024

Related U.S. Application Data
(63) Continuation of application No. PCT/US22/42310, filed on Sep. 1, 2022.
(60) Provisional application No. 63/241,266, filed on Sep. 7, 2021.

(51) Int. Cl. A47J 37/07; A47J 36/04

(52) U.S. Cl. CPC A47J 37/0786; A47J 36/04

(57) ABSTRACT

The present disclosure is directed to an improved design for a pizza oven insert for use with a barbecue grill or smoker. In one form, an oven insert comprises a base defining an aperture; an exterior enclosure positioned on a top of the base; an interior wall positioned within an interior area defined at least partially by the exterior enclosure, the interior wall defining an aperture at a top inner wall of the interior wall; and a cooking insert positioned below the aperture defined by the top inner wall and positioned above the aperture defined by the base. The exterior enclosure and the interior wall are positioned within the oven insert to provide an airflow from the aperture at the bottom of the base, through a hollow chamber between the exterior enclosure and the interior wall, and through the aperture defined by the top inner wall.

### RELATED APPLICATIONS

The present application is a continuation of PCT Application No. PCT/US22/42310, filed Sep. 1, 2022, which claims priority to U.S. Provisional Patent Application No. 63/241,266, filed Sep. 7, 2021, the entirety of each of which is hereby incorporated by reference.

### BACKGROUND

Conventional pizza inserts for barbecue grills heat a pizza from below and divert air out the front of the insert. While an effective way to accommodate pizza cooking on a barbecue grill or smoker, such pizza inserts are not comparable to pizza ovens when paired with a grill primarily constructed from metal as opposed to ceramic.

### SUMMARY OF THE DISCLOSURE

The present disclosure provides an improved design for a pizza oven insert for use with a barbecue grill or smoker.

In one form, the present disclosure provides an oven insert comprising: a base defining an aperture at a bottom of the base; an exterior enclosure positioned on a top of the base; an interior wall positioned within an interior area defined at least partially by the exterior enclosure, the interior wall defining an aperture at a top inner wall of the interior wall; and a cooking insert positioned within an interior area defined at least partially by the interior wall below the aperture defined by the top inner wall and positioned above the aperture defined by the base. The exterior enclosure and the interior wall are positioned within the oven insert to provide an airflow from the aperture at the bottom of the base, through a hollow chamber between the exterior enclosure and the interior wall, and through the aperture defined by the top inner wall.

In another form, the present disclosure provides an oven insert comprising: a base defining an aperture at a bottom of the base; a cooking insert positioned above the aperture of the base; an exterior enclosure positioned at least partially over the base, the exterior enclosure defining at least one of a front opening and a rear opening; and an inner wall positioned within an interior of the exterior shell, the inner wall defining an aperture at a top inner wall of the inner wall. The inner wall is positioned within the oven insert with respect to the exterior enclosure to provide an airflow from the aperture at the bottom of the base, between the exterior enclosure and the inner wall, through the aperture at the top inner wall into the interior of the inner wall, and out of the at least one of the front opening or the second opening.

### BRIEF DESCRIPTION OF THE DRAWINGS

FIG. 1 is a perspective view of one form of a pizza oven insert.

FIG. 2 is a front view of the pizza oven insert of FIG. 1.

FIG. 3 is a rear view of the pizza oven insert of FIG. 1.

FIG. 4 is a first side view of the pizza oven insert of FIG. 1.

FIG. 5 is a second side view of the pizza oven insert of FIG. 1.

FIG. 6 is a top view of the pizza oven insert of FIG. 1.

FIG. 7 is a bottom view of the pizza oven insert of FIG. 1.

FIG. 8 is a cross-sectional perspective view of the pizza oven insert of FIG. 1.

FIG. 9 is a first perspective view of one form of a heat directing insert.

FIG. 10 is a second perspective view of the heat directing insert of FIG. 9.

### DETAILED DESCRIPTION OF THE DRAWINGS

Embodiments and implementations of the present disclosure provide a pizza oven insert for use with a barbecue grill or smoker. In some implementations described below, a pizza oven insert comprises an enclosure and a cooking insert such as a ceramic pizza stone for receiving a pizza. Forms of the improved pizza oven insert are designed so that heat can be directed from below the cooking insert, through side walls of the enclosure to a top of the enclosure, and out of opening at the front and/or back of the pizza oven insert. In some implementations, the pizza oven insert can be used in combination with a heat directing insert that is configured to direct heat from a fuel source to the bottom of the pizza oven insert. This improved design allows for a pizza to cook evenly throughout in under 5 minutes. In some implementations, the pizza oven insert can be configured to fit in a barbecue grill or smoker such as that shown and described in U.S. Patent Application Publication No. 2020/0093145, filed Aug. 8, 2019, titled “Gravity Fed Smoker.”

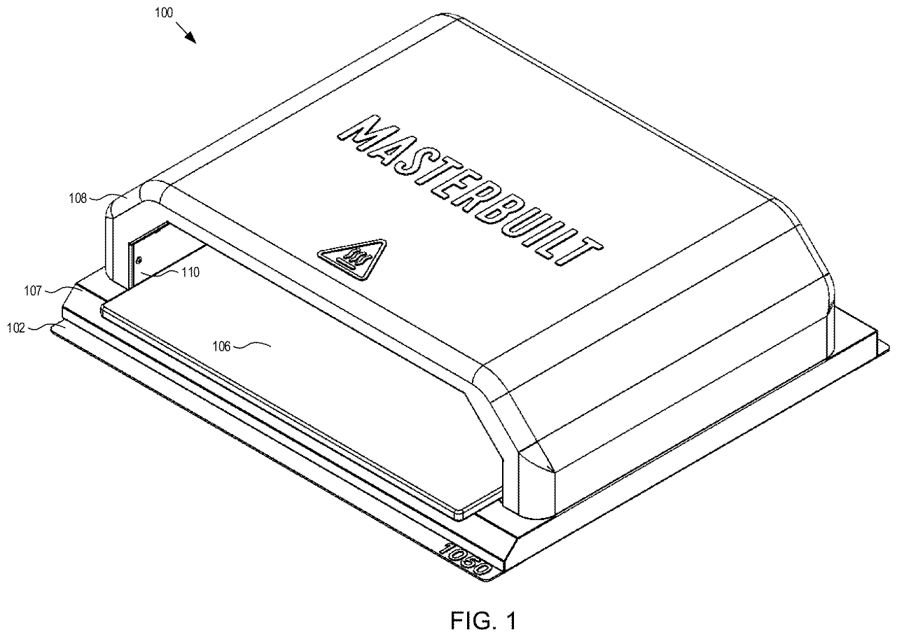

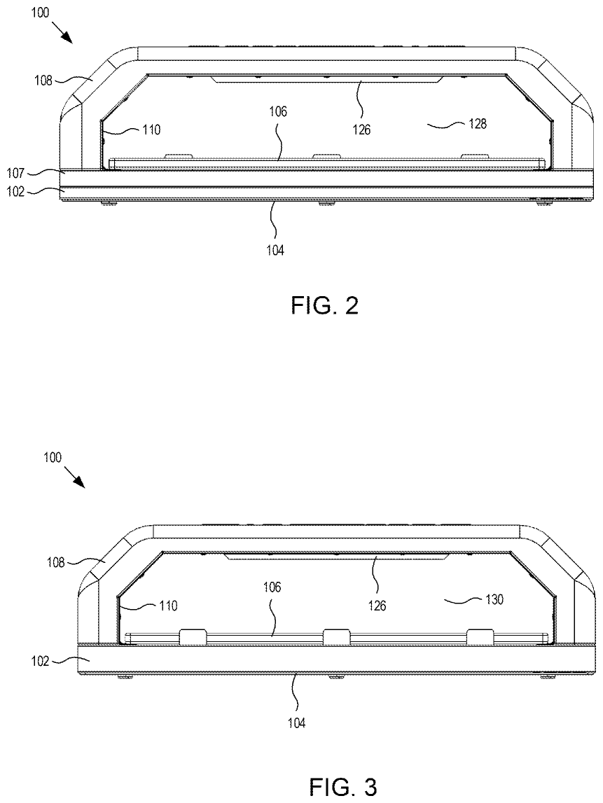

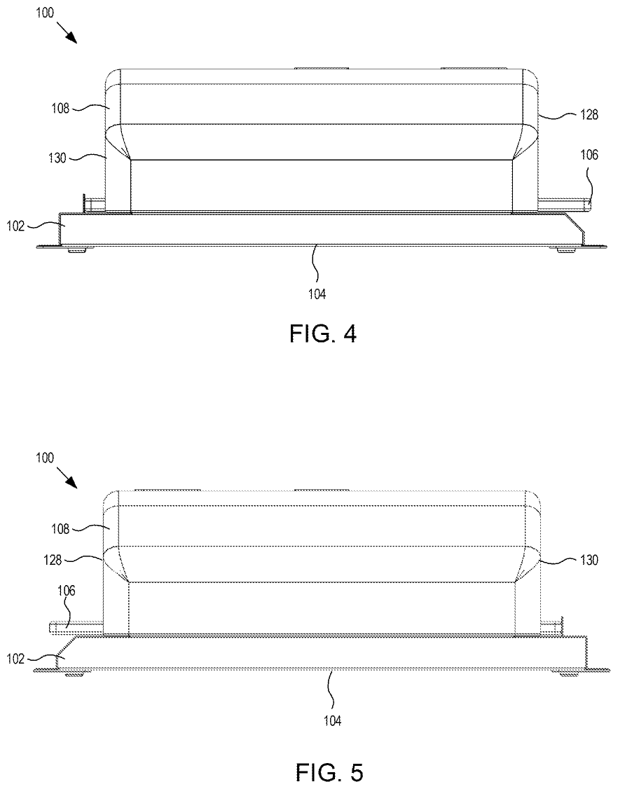

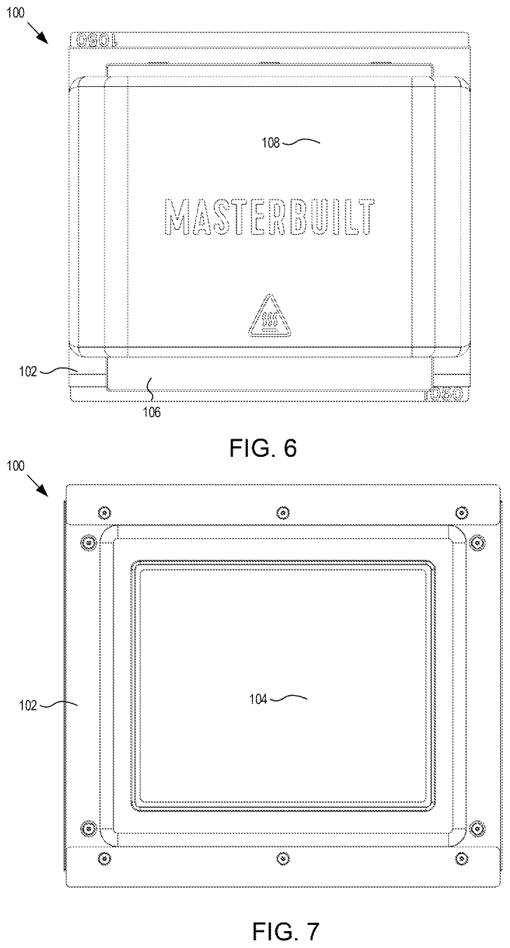

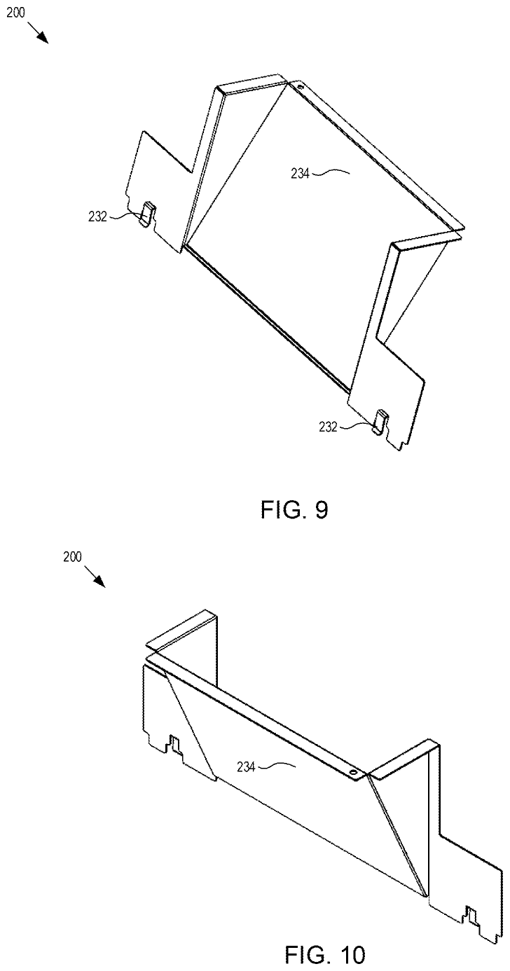

FIGS. 1-8 illustrate an exemplary pizza oven insert 100 and FIGS. 9 and 10 illustrate an exemplary heat directing insert 200. In some implementations, the illustrated pizza oven insert 100 and heat directing insert 200 may be used with a barbecue grill or smoker such as that shown and described in U.S. Patent Application Publication No. 2020/0093145.

Referring to FIGS. 1-8, in some implementations, a pizza oven insert 100 comprises a base 102 that is configured to replace a grill grate when used in combination with a barbecue grill and smoker. In other implementations, the base 102 is configured to sit on top of a grill grate. The base 102 defines an aperture 104 at a bottom of the pizza insert 100 through which heat can be received and delivered to the pizza oven insert 100. In some implementations, the aperture 104 is one large opening as illustrated in the drawings. However, in other implementations, the base 102 may define a plurality of smaller apertures that together generally form a large opening. The aperture 104 may be a rectangular shape as shown in the drawings or can be any other suitable shape as required to facilitate delivery of heat through the pizza oven insert 100.

The pizza oven insert 100 further comprises a cooking insert 106, such as a ceramic pizza stone, where a pizza can be placed during cooking. The cooking insert 106 is configured to rest above the aperture 104 defined by the base 102. In some implementations, the pizza oven insert 100 may comprise a ledge 107, defined by the base 102, that is configured to support the cooking insert 106 and position it above the aperture 104 defined by the base.

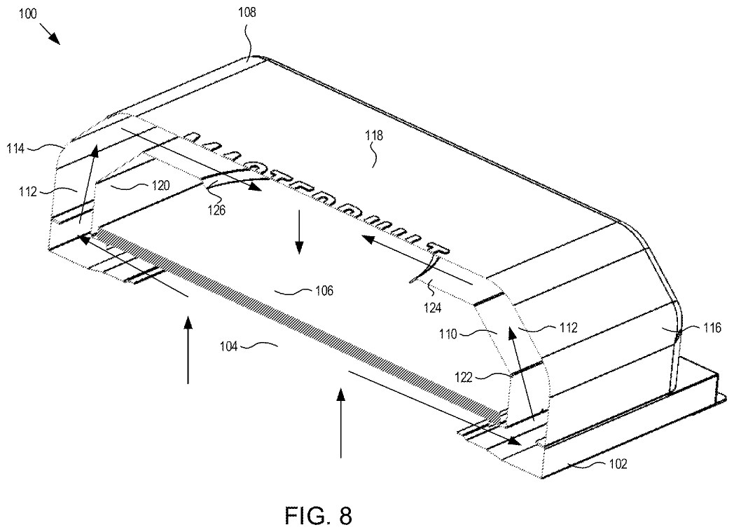

The pizza oven insert 100 further comprises an exterior enclosure 108. The exterior enclosure 108 is positioned on the base 102 and defines at least partially an interior area. An interior wall 110 is positioned within the interior area defined by the enclosure 108 such that a hollow chamber 112 is defined between the exterior enclosure 108 and the interior wall 110, as shown in FIG. 8. More specifically, the exterior enclosure defines at least a first exterior side wall 114, a second exterior side wall 116, and a top exterior wall 118. The interior wall 110 defines at least a first inner side wall 120, a second inner side wall 122, and a top inner wall 124. The hollow chamber 112 is defined between at least the first exterior side wall 114 and the first inner side wall 120, between the second exterior side wall 116 and the second inner side wall 122, and between the top exterior wall 118 and the top inner wall 124.

The interior wall 110 defines an aperture 126 at the top interior wall 124 of the interior wall 110 above the cooking insert 106. The aperture 126 at the top interior wall 124 allows air to flow from the hollow chamber 112 and into an interior area defined at least partially by the interior wall 110. In some implementations, the aperture 126 defined by the interior wall 110 above the cooking insert 106 is one large opening as illustrated in the drawings. However, in other implementations, the interior wall 110 may define a plurality of smaller apertures that together generally form a large opening. The aperture 124 may be a circular shape as shown in the drawings or can be any other suitable shape as required to facilitate delivery of heat through the pizza oven insert 100.

It will be appreciated that the above-described structure of the pizza oven insert 100 provides an airflow from the aperture 104 defined by the base 102, through the hollow chamber 112 between the exterior enclosure 108 and the interior wall 100, out of the aperture 124 defined by the interior wall 110, onto the cooking insert 106, and out of the pizza oven insert 100 at a front opening 128 and/or a rear opening 130 of the pizza oven insert 100.

In some implementations, the pizza oven insert 100 is constructed from steel coated in porcelain. However, in other implementations, the pizza oven insert 100 can comprise other materials.

FIGS. 9 and 10 illustrate a heat directing insert 200 which can be used for directing heat towards the pizza oven insert 100. The heat directing insert 200 is configured to couple with a manifold of a grill that delivers heat to the cooking area of the grill, such as that shown in U.S. Patent Application Publication No. 2020/0093145. In some implementations, the heat directing insert 200 comprises one or more tabs 232 that are configured to couple with one or more holes within the manifold of the grill. The heat directing insert defines a funnel 234 that can then be positioned within the grill beneath the pizza oven insert 100 to direct heat towards the base 102 of the pizza oven insert 100. In some implementations, more than one heat directing insert 200 can be used with the manifold of the grill to direct heat towards pizza oven insert 100.

Although embodiments and implementations of the present disclosure have been described in detail above, the present disclosure is not limited to these specific embodiments and implementations, and various modifications and changes can be made within the scope of the disclosure. Therefore, it is intended that this disclosure not be limited to the particular embodiments and implementations disclosed, but that the disclosure will include all embodiments and implementations falling within the scope of the appended claims.

1. An oven insert comprising:
a base defining an aperture at a bottom of the base;
an exterior enclosure positioned on a top of the base;
an interior wall positioned within an interior area defined at least partially by the exterior enclosure, the interior wall defining an aperture at a top inner wall of the interior wall; and
a cooking insert positioned within an interior area defined at least partially by the interior wall below the aperture defined by the top inner wall and positioned above the aperture defined by the base;
wherein the exterior enclosure and the interior wall are positioned within the oven insert to provide an airflow from the aperture at the bottom of the base, through a hollow chamber between the exterior enclosure and the interior wall, and through the aperture defined by the top inner wall.

2. The oven insert of claim 1, wherein the cooking insert is a ceramic stone.

3. The oven insert of claim 1, wherein the aperture at the bottom of the base is rectangular in shape.

4. The oven insert of claim 1, wherein the aperture at the top of the inner wall is circular in shape.

5. The oven insert of claim 1, wherein:
the exterior enclosure defines at least one of a front opening or a back opening; and
the at least one of the front opening or the back opening are configured to provide airflow from the interior area defined by at least partially by the interior wall out of the oven insert.

6. The oven insert of claim 1, wherein:
the exterior enclosure defines a first exterior side wall, a second exterior side wall, and a top exterior wall;
the interior wall defines a first inner side wall, a second inner side wall, and the top inner wall; and
the airflow flows between the first exterior side wall and the first inner side wall, between the second exterior side wall and the second inner side wall, and between the top exterior wall and the top inner wall.

7. The oven insert of claim 1, wherein at least one of the base, the exterior enclosure, and the inner wall is porcelain coated.

8. The oven insert of claim 1, wherein the oven insert is configured to couple with a heat directing insert that is configured to direct heat towards the aperture at the bottom of the base.

9. The oven insert of claim 8, wherein the heat directing insert is configured to be coupled with a manifold of a grill.

10. The oven insert of claim 1, further comprising:
a ledge;
wherein at least a portion of the cooking insert rests on the ledge when the cooking insert is positioned within the interior area defined at least partially by the interior wall.

11. An oven insert comprising:
a base defining an aperture at a bottom of the base;
a cooking insert positioned above the aperture of the base;
an exterior enclosure positioned at least partially over the base, the exterior enclosure defining at least one of a front opening and a rear opening; and
an inner wall positioned within an interior of the exterior shell, the inner wall defining an aperture at a top inner wall of the inner wall;
wherein the inner wall is positioned within the oven insert with respect to the exterior enclosure to provide an airflow from the aperture at the bottom of the base, between the exterior enclosure and the inner wall, through the aperture at the top inner wall into the interior of the inner wall, and out of the at least one of the front opening or the second opening.

12. The oven insert of claim 11, wherein the oven insert is configured to couple with a heat directing insert that is configured to direct heat towards the aperture at the bottom of the base, wherein the heat directing insert is further configured to be coupled with a manifold of a grill.

13. The oven insert of claim 11, wherein the cooking insert is a ceramic stone.

14. The oven insert of claim 11, wherein the aperture at the bottom of the base is rectangular in shape.

15. The oven insert of claim 11, wherein the aperture at the top of the inner wall is circular in shape.

16. The oven insert of claim 1, wherein at least one of the base, the exterior enclosure, and the inner wall is porcelain coated.
